(19) United States
(12) Patent Application Publication
(10) Pub. No.: US 2013/0033056 A1
(43) Pub. Date: Feb. 7, 2013

(54) Energy absorbing system for blast mitigation of support elements such as suspended seats or stretchers in military vehicles

(71) Applicants: George C. Tunis, III, Ocean City, MD (US); Scott Kendall, Berlin, MD (US)

(72) Inventors: George C. Tunis, III, Ocean City, MD (US); Scott Kendall, Berlin, MD (US)

(21) Appl. No.: 13/506,808

(22) Filed: May 17, 2012

Related U.S. Application Data
(60) Provisional application No. 61/574,610, filed on Aug. 5, 2011.

(51) Int. Cl. F16F 7/12; A61G 3/00; B60N 2/427; B60N 2/42

(52) U.S. Cl. 296/19; 297/216.1; 296/64; 188/376

(57) ABSTRACT

An energy absorbing system for blast mitigation is provided for a suspended support element, such as a gunner seat or medical stretcher, in a vehicle. An energy absorbing element is located in series within at least one suspension element of the seat or stretcher. The energy absorbing element includes an extensible section having a contracted, folded configuration and an extended configuration. A retention element, such as stitching or entangled interlocking fibers, retains the energy absorbing element in the contracted configuration. The retention element remains intact when the energy absorbing element supports a load from the person on the seat or stretcher and fails over a period of time when an explosive force is applied to the vehicle from underneath, causing the vehicle to move upwardly, the extensible section thereby extending in length and absorbing energy. Injury to the person can thereby be reduced.

### CROSS-REFERENCE TO RELATED APPLICATIONS

This application claims priority under 35 U.S.C. §119(e) of U.S. Provisional Patent Application No. 61/574,610, filed on Aug. 5, 2011, the disclosure of which is incorporated by reference herein.

### BACKGROUND OF THE INVENTION

In some military vehicles, a weapons mount is provided in the center. The weapons mount includes an opening formed in the vehicle roof. A seat for a gunner is suspended below the opening, typically by straps made from tightly woven webbing. The gunner sits in the seat such that a portion of the upper body extends through the opening to operate a weapon mounted to the weapons mount. Such military vehicles may be subject to under-belly blasts from improvised explosive devices (IEDs), mines, and other explosive events. These under-belly blasts can accelerate the occupant of the gunner seat upwardly out of the vehicle.

In other military vehicles, seats are suspended from the ceiling of the vehicle. In military vehicles for medical purposes, stretchers for injured personnel are suspended from the ceiling of the vehicle. An under-belly blast can propel an occupant of the seat or stretcher into the ceiling.

### SUMMARY OF THE INVENTION

An energy absorbing system for blast mitigation is provided for a support element, such as a suspended gunner seat or a medical stretcher, for a person in a vehicle. The system includes an energy absorbing element disposed in series with at least one suspension element of the seat or other support element. The energy absorbing element is a longitudinal element, such as a woven strap, capable of carrying a tensile load. The energy absorbing element comprises an extensible section having a contracted configuration. The extensible section is configured with an initiation force to initiate extension from the contracted configuration, such that when a load on the vehicle is below the initiation force, no extension occurs and the support element is retained in suspension below the upper end, and when a load is applied to the vehicle that is above the initiation force, the extensible section extends in a controlled manner that absorbs energy.

The contracted configuration comprises one or more folds of the extensible section retained in a folded orientation with adjacent portions abutting. A retention element is disposed to retain the extensible section in the contracted configuration. The retention element is configured to remain intact when the energy absorbing element, in series with the suspension element, supports a load from the person on the support element and to fail over a period of time, for example, to pull apart or rip apart, when an explosive force is applied to the vehicle from underneath, causing the vehicle to move upwardly. As the retention element fails, the extensible section extends in length and absorbs energy of the blast, so that the energy does not return back into the system. In this manner, injury to the person may be reduced. In one embodiment, the retention element comprises stitching through the adjacent portions of the folded extensible section. In another embodiment, the retention element comprises entangled interlocking fibers formed by needle punching adjacent portions of the folded extensible section.

A safety strap can be provided in parallel with the energy absorbing element to carry the load if the energy absorbing element extends fully and breaks apart, minimizing the possibility of the support element ejecting from the vehicle. The extensible element in the contracted configuration, with the safety strap if present, can be packaged in a breakaway casing to keep the folds of the extensible section in the contracted configuration and to protect the energy absorbing element from inadvertent damage under normal conditions.

In other aspects, the system can include a retraction mechanism located at an upper end of the suspension element. The support element can be constrained to move vertically by a vertical guide bar.

### DESCRIPTION OF THE DRAWINGS

The invention will be more fully understood from the following detailed description taken in conjunction with the accompanying drawings in which:

FIG. 1 is a schematic illustration of an energy absorbing system of the present invention in conjunction with a gunner seat in a military vehicle;

FIG. 2 is a schematic side view of the energy absorbing system of FIG. 1;

FIG. 3 is a schematic illustration of an energy absorbing element in a contracted configuration used in the energy absorbing system of FIG. 1;

FIG. 4 is a schematic illustration of the energy absorbing element of FIG. 3 during extension;

FIG. 5 is a side view of an energy absorbing element in a contracted configuration used in the energy absorbing system of FIG. 1;

FIG. 6 is a front view of the energy absorbing element of FIG. 5;

FIG. 7 is a side view of a further embodiment of an energy absorbing element in a contracted configuration;

FIG. 8 is a side view of a still further embodiment of an energy absorbing element in a contracted configuration;

FIG. 9 is a schematic view of a further embodiment of an energy absorbing element in a partially extended configuration;

FIG. 10 is an illustration of an energy absorbing element and a safety strap;

FIG. 11 is a schematic side view of the energy absorbing element and safety strap in a contracted configuration;

FIG. 12 is a schematic side view of an energy absorbing system in conjunction with a gunner seat in a military vehicle;

FIG. 13 is a plan view of an energy absorbing element in a contracted configuration with a safety strap and fixtures;

FIG. 14 is a schematic, partial cross-sectional view of the energy absorbing element of FIG. 13 with a breakaway casing;

FIG. 15 is a schematic illustration of an energy absorbing system in conjunction with a suspended stretcher in a vehicle;

FIG. 16 is a schematic illustration of an energy absorbing system in conjunction with a suspended seat in a vehicle with a retraction mechanism;

FIG. 17 is a schematic side view of the system of FIG. 16;

FIG. 18 is a schematic side view of a suspended seat with an energy absorbing system further incorporating vertical guide bars;

FIGS. 19A-19D are schematic illustrations of the seat of FIG. 18 undergoing a blast event.

FIG. 20 is an illustration of a simple model of a vehicle with a suspended gunner seat without an energy absorbing system of the present invention;

FIG. 21 is an illustration of a simple model of a vehicle with a suspended gunner seat using an energy absorbing system of the present invention;

FIG. 22 is a graph of transient results of a blast event on the model of FIG. 20;

FIG. 23 is a graph of transient results of a blast event on the model of FIG. 21 using the energy absorbing system;

FIG. 24A is a graph of acceleration vs. time of a test of a crew seat without an energy absorbing device;

FIG. 24B is a graph of acceleration vs. time of a test of a crew seat with an energy absorbing device;

FIG. 25A is a graph of acceleration vs. time of a test of a sling seat without an energy absorbing device;

FIG. 25B is a graph of acceleration vs. time of a test of a sling seat with an energy absorbing device.

### DETAILED DESCRIPTION OF THE INVENTION

The disclosure of U.S. Provisional Patent Application No. 61/574,610, filed on Aug. 5, 2011, is incorporated by reference herein.

During blast-induced motion of the vehicle, there are three phases of concern for the occupants: take-off, ejection, and landing. During the take-off phase, the vehicle realizes a sudden vertical velocity, while the occupants are essentially motionless, putting the vehicle on a collision course with the occupants. High vertical forces are placed on the occupants through, for example, their seats, as they are accelerated to the vertical speed of the vehicle. These large accelerations can cause considerable injury.

As the occupants are forced upwardly during the take-off phase, the elastic load-carrying elements that carry their load store energy like a spring. This energy comes back out as the vehicle slows at the apex of its trajectory, and further accelerates the occupant upwardly relative to the vehicle, tending to eject the occupant. This upward motion continues until a) the force of gravity causes the occupant to descend, b) a restraining harness acts to hold the occupant down, c) the occupant hits the roof if there is one, or d) the occupant is ejected upwardly, possibly out of the vehicle, as in the case of the gunner. The softer the elastic elements are that support the occupant, the softer the initial take-off forces are, but the greater is the tendency for ejection. Once the vehicle reaches the apex of its trajectory, it begins to accelerate downwardly under the force of gravity until it hits the ground and comes to rest. This sudden stop (i.e. deceleration) on landing can also cause injury to the occupant.

While advancements in seat design have reduced the effects of these three phases on the occupants, there are some exceptions. One exception is the gunner seat in a military vehicle, such as a high mobility multipurpose wheeled vehicle (HMMWV), that uses only webbing, for example, seat-belt webbing, to make and suspend the seat.

More particularly, the typical gunner seat suspension system is formed of nylon or another polymer fiber rope and/or webbing, which offers some compliance during a blast event to help soften the acceleration delivered to the occupant. This compliance acts much like a spring and stores the energy as the occupant is driven down as a result of the sudden upward movement of the vehicle. The challenge in designing the compliance “spring” into the suspension ropes and webbing is that the stored energy tends to come out shortly after the blast, as the occupant tends to become weightless for a brief time and is propelled upwardly. Thus, a restraint strap is typically provided to keep the occupant from being launched upwardly after the initial vertical jump, but causing other injury. Thus, the desire to make the system more compliant, to better soften the initial acceleration, only works to worsen the launching effect; softer springs tend to store more energy. In addition, springs are not efficient energy absorbers because they do not absorb much energy at the start of the stroke, so there is wasted displacement that could be used to save the occupant.

Accordingly, an energy absorbing system is provided to address this problem by introducing one or more energy absorbing elements, in the form of a constant load damping mechanism, into a suspension system for support elements such as seats or stretchers in vehicles. By way of explanation, the energy absorbing element herein is analogous to a single-direction “Coulomb damping” effect (a “Coulomb damper” or “C-Damper”) in series with the suspension elements, such as ropes and/or straps. A Coulomb damper is also typically referred to as a friction damping device, in which the relative motion of the damper initiates at a load level commonly referred to as the static friction value, and then holds a constant, possibly different, force as the device actuates, termed the dynamic friction value. The energy absorbing elements described herein for a suspension system do not necessarily use friction as the mechanism to resist motion, but they do approximate the behavior of a Coulomb damper in that they have an initiation load, and a nearly constant load as the energy absorbing element extends, described further below.

In conjunction with the energy absorbing element, the remainder of the suspension system can be made as stiff as possible. That is, the suspension elements, the straps and/or ropes suspending the seat, can be formed to be as stiff as possible, like a stiff spring, to minimize the launching effect, and allow the energy absorbing element to provide the majority of the displacement at constant or near-constant restraining load. This effectively doubles the energy that is absorbed for a given displacement, without overloading the occupant. The energy absorbing elements store the energy in a non-conservative way, as, for example, broken fibers (described further below), not as a spring, so the energy cannot come back out into the system.

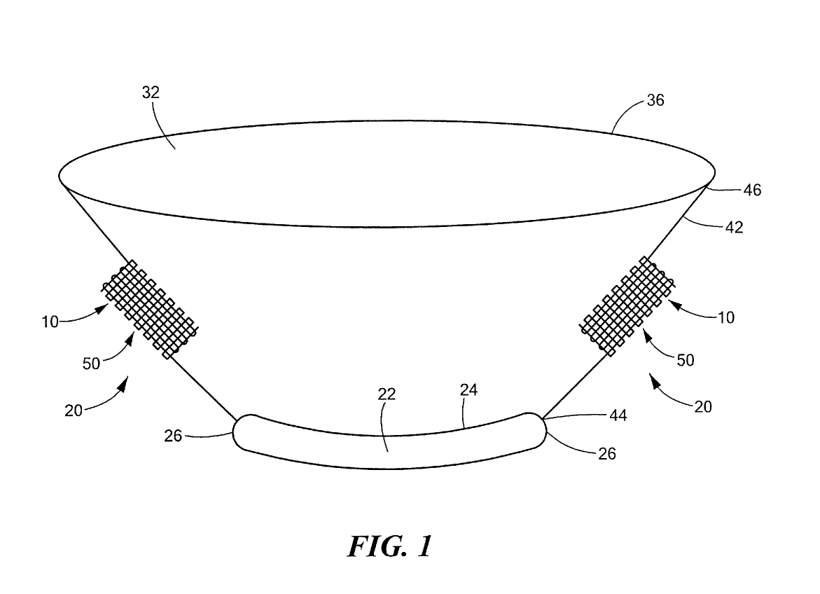

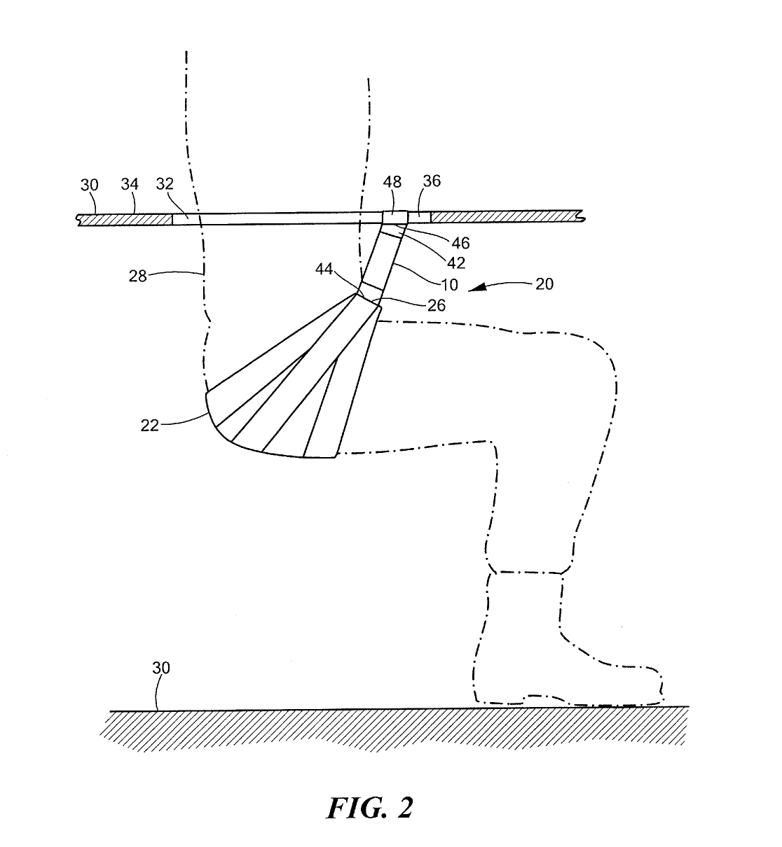

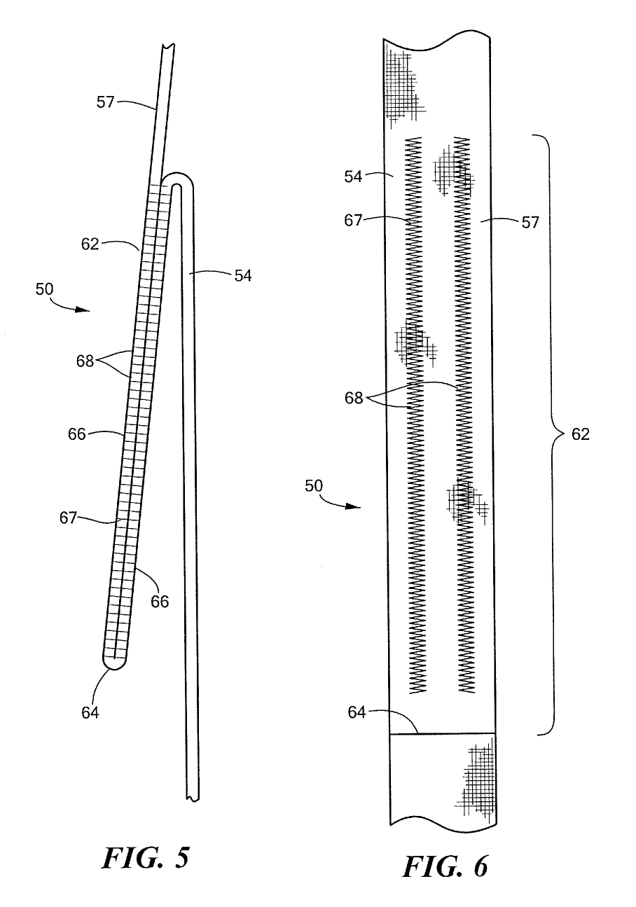

One exemplary embodiment of the energy absorbing system 10 is illustrated in FIGS. 1-6. The system is illustrated in conjunction with a suspension system 20 for a gunner seat in a vehicle 30, such as a HMMWV. The suspension system 20 includes a support element 22, e.g., the gunner seat, having an upwardly facing support surface 24 extending between opposed edges 26. In the case of a gunner seat, the support element 22 is typically formed from a woven webbing or other flexible material to conform to the gunner's body 28 when seated (illustrated in phantom in FIG. 2). The support element 22 is suspended beneath an opening 32 in a roof 34 of the vehicle 30 with one or more suitable suspension elements 42. For the gunner seat, the suspension system includes at least two longitudinally extending suspension elements 42 such as straps that extend between each side edge 26 of the seat 22 and the frame 36 or other suitable structural component of the vehicle 30. The straps are also typically formed from a woven webbing, such as seat-belt webbing, which may be the same material used for the gunner seat. The straps may be formed integrally with the gunner seat webbing or may be attached thereto via any suitable attachment fixture, which may also allow detachment if desired. The woven webbing material is typically nylon, although other suitable materials, such as other polymeric or natural fibers, may be used.

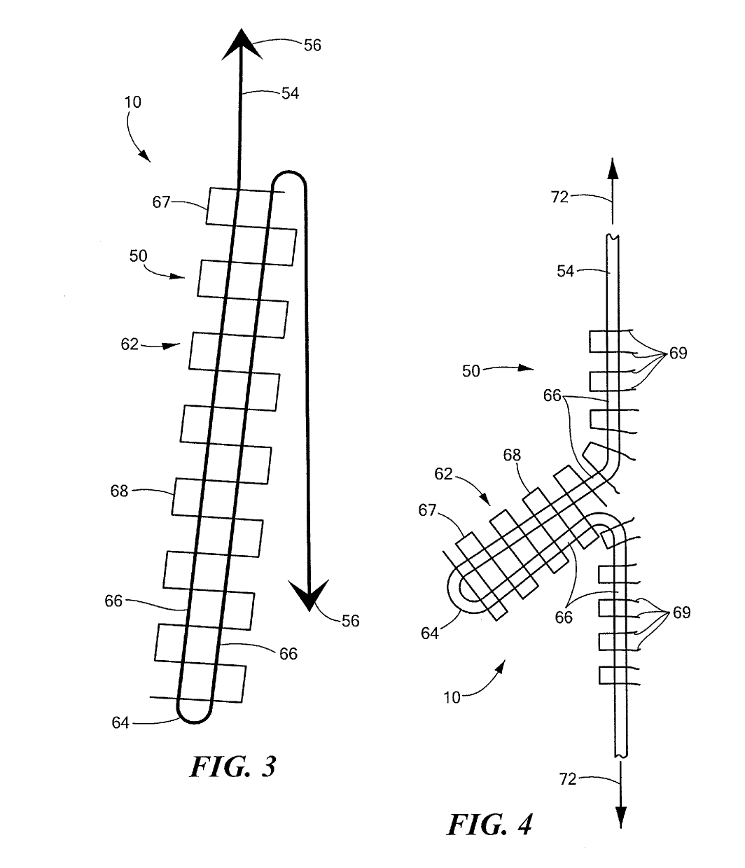

The energy absorbing system 10 includes an energy absorbing element 50 disposed in series with at least one of the suspension elements 42. Referring to FIGS. 3-6, the energy absorbing element 50 is a longitudinal element 54 capable of carrying a tensile load (indicated schematically by arrowheads 56 in FIG. 3), such as a strap of woven webbing as described above. The longitudinal element includes an extensible section 62 that is foldable with one or more folds 64 into a contracted configuration. Adjacent portions 66 are retained in the folded, contracted configuration by a suitable retention element 68.

In one embodiment, the retention element 68 is formed by stitching 67 that extends through adjacent portions 66 to hold them together in abutting relationship, indicated schematically in an expanded manner in FIGS. 3 and 4. The stitching holds together under normal loading conditions, such as when a gunner is sitting in the seat (FIG. 2). At a determined greater load, termed the initiation load (indicated schematically by arrows 72 in FIG. 4), the stitching is capable of failing sequentially by ripping apart, thereby absorbing energy as broken fibers 69 while the extensible section 62 extends. The initiation load for failure of the stitching is selected to be above the usual operational load on the suspension system (e.g., a gunner in the seat) and less than the failure load of the woven webbing itself used in forming the components of the suspension system.

In operation, when a blast event occurs beneath the vehicle, the vehicle is propelled upwardly, and the gunner seat and gunner are propelled upwardly as well. The retention element, for example, the stitching, in the extensible section of the energy absorbing element fails over a period of time, which allows the strap of the energy absorbing element 50 to extend and absorb energy as the gunner seat is propelled upwardly. In this manner, the load on the gunner is slowed at a nearly constant rate. In addition, the woven webbing, such as seat belt webbing, that forms the suspension elements and the extensible section can be formed to be as stiff as possible, which helps to minimize the launching effect and the return of energy to the system.

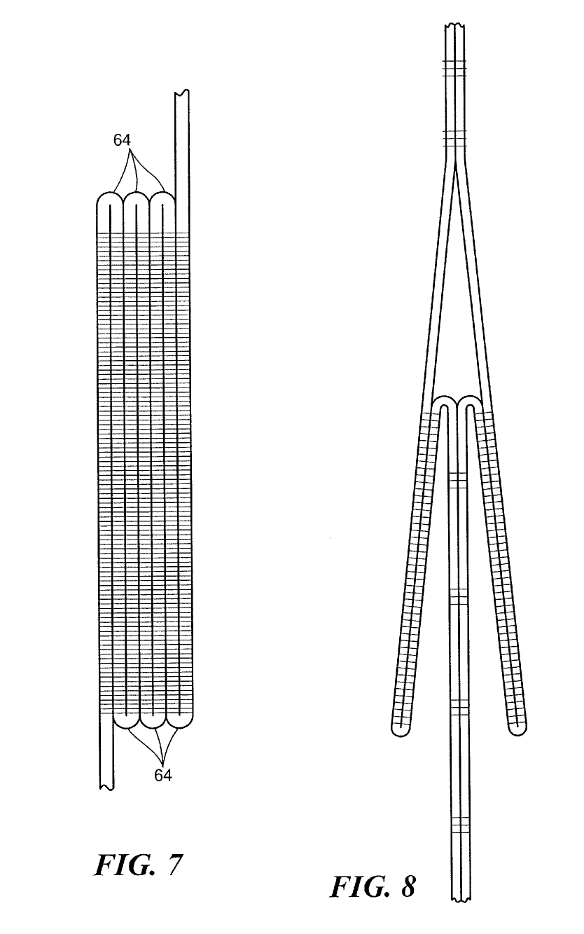

Any number of folds can be provided, which can be readily determined by the expected loads for the application and the materials used. Any suitable stitching can be used. FIG. 6 illustrates two rows of a zig-zag form of stitching. However, the type of stitching can be varied, and any number of rows may be used, as can be determined by the application. FIG. 7 illustrates an embodiment of an energy absorbing system that employs six folds 64. FIG. 8 illustrates a further embodiment of an energy absorbing system that employs a double layer of webbing to provide two oppositely disposed extensible sections arranged in parallel. The double layer can be prepared by attaching two sections of woven webbing together above and below the extensible section by stitching or in any other suitable manner. Any suitable fiber material such as nylon or another polymeric or natural fiber material, may be used for the stitching. Those of ordinary skill in the art can readily determine the number of folds, type and amount of stitching.

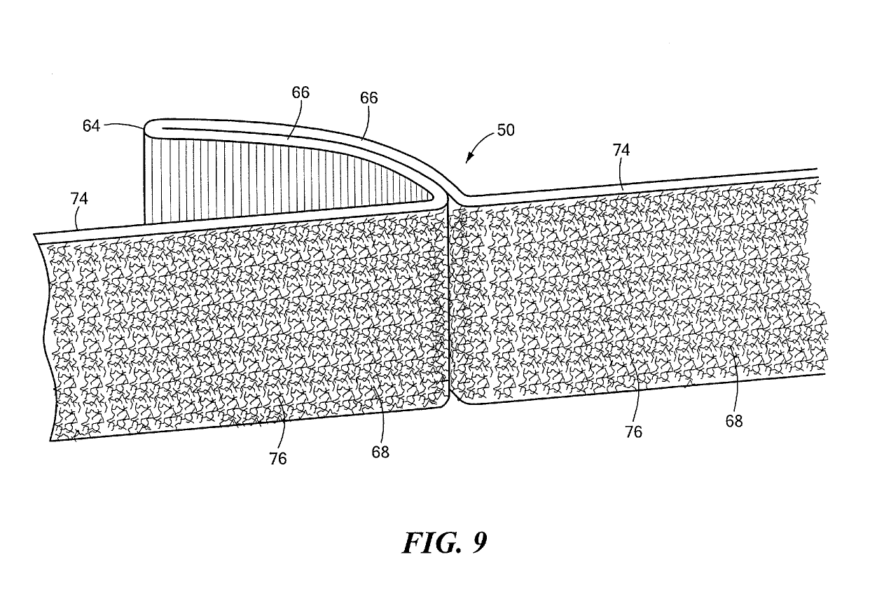

In a further embodiment, the retention element 68 is formed by needle punching or needle felting the adjacent portions 66 to hold them together in abutting relationship. A needle punch operation is performed by inserting a plurality of barbed needles, typically on a needle board, through the adjacent portions of the energy absorbing portion from one or both sides. The energy absorbing portion can be formed from a woven webbing, such as seat belt webbing, or other fibrous materials, including non-woven materials. The barbs on the needles catch fibers as the needles penetrate, pushing the fibers from one portion 66 through to an adjacent portion 66, entangling the fibers. The entangled fibers thereby become mechanically interlocked. The interlocked fibers hold together under normal loading conditions. The interlocked fibers are capable of pulling apart at a determined greater load, the initiation load, thereby absorbing energy while the extensible section 62 extends over time. FIG. 9 schematically illustrates a needle punched energy absorbing element 50 in a partially extended configuration, in which sections 74 of the needle punched adjacent portions 66 have been separated, exposing broken-apart entangled fibers 76. The initiation load for pulling apart the entangled fibers is selected to be above the usual operational load on the suspension system (e.g., a gunner in the seat) and less than the failure load of the suspension system. The initiation load can be tailored by, for example, selecting a suitable density of needle penetrations, which can be controlled by the needle density on the needle board, the frequency of needle penetrations, and the material feed rate during needle punching.

The retention element can have other configurations. For example, the retention element can be formed from an adhesive, staples, or hook and loop type fasteners.

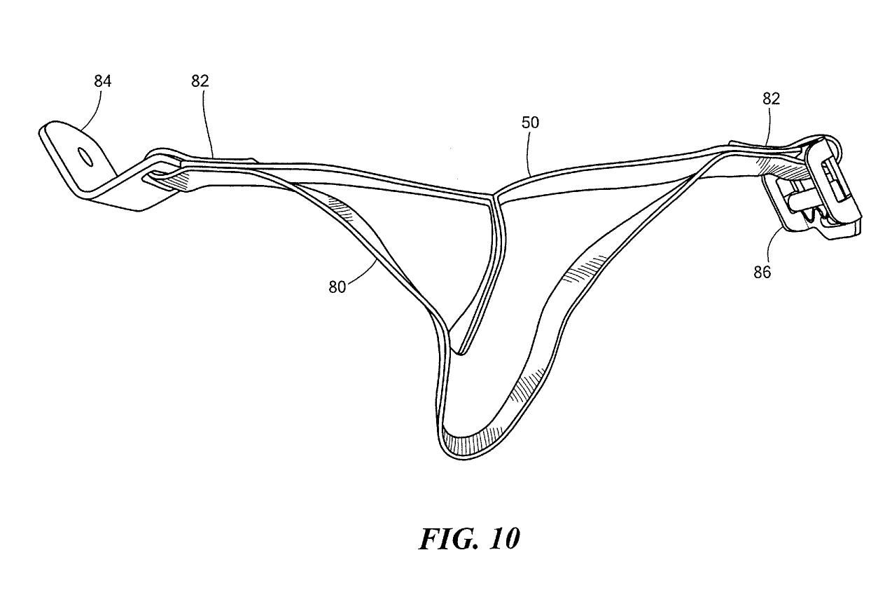

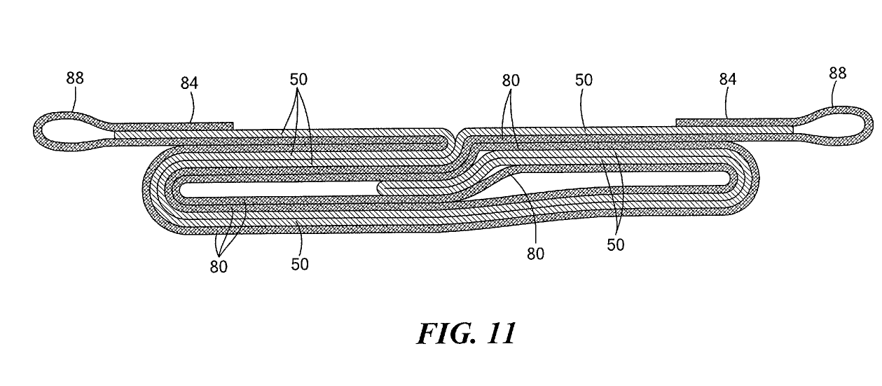

Referring to FIGS. 10 and 11, a safety strap 80 can be added in parallel with the energy absorbing element 50. The length of the safety strap is somewhat longer than the length of the energy absorbing element when fully extended. If the energy absorbing element reaches its full extension and breaks apart, the load is transferred to the safety strap. (In FIG. 10, the energy absorbing element is shown partially extended.) The safety strap is formed from a material, such as seat belt webbing, selected to have a greater tensile strength than the initiation load for the energy absorbing element, minimizing the likelihood of the safety strap breaking. This minimizes the possibility that the seat or other support element could detach and be fully ejected from the vehicle. The safety strap also prevents the occupant from moving freely within the vehicle should the retention element fail as the occupant sinks into the vehicle on takeoff. At each end 82, the safety strap is connected to an end of the energy absorbing element, such as with strong stitching that does not rip apart at the initiation load. Brackets 84, 86 for connecting in series with the suspension system and/or the structure of the vehicle can be attached to the safety strap, for example, through loops 88 formed at each end 82. The safety strap 80 can be folded up with the energy absorbing element to form a compact package, as illustrated in FIG. 11.

The energy absorbing element can be connected in series with the suspension element in any suitable manner. In FIG. 1, the energy absorbing element 50 is formed as an integral part of the suspension element, located between the lower end 44 and the upper end 46. The energy absorbing element may be formed integrally with the suspension element by forming the suspension element with a length sufficient to form a folded section, as shown schematically in FIG. 1. Alternatively, the energy absorbing element may be attached within the suspension element by any suitable attachment fixture(s), which may include mechanical fasteners or further stitching. The upper end 46 of the suspension element is attachable with a suitable attachment fixture 48 (FIG. 2) to the frame 36 or other suitable structural component of the vehicle 30. Any suitable attachment fixture can be used, which may also allow detachment if desired. The lower end is also attachable with a suitable attachment fixture to the support element. The suspension element can be adjustable via strap adjustment fixtures (not shown), so that the occupant can adjust the height of the seat, if desired.

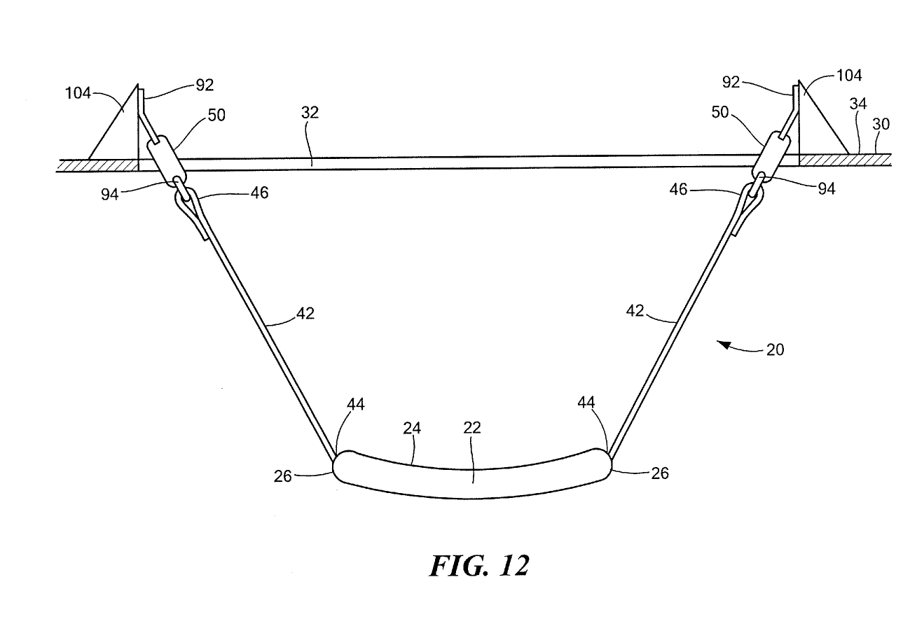

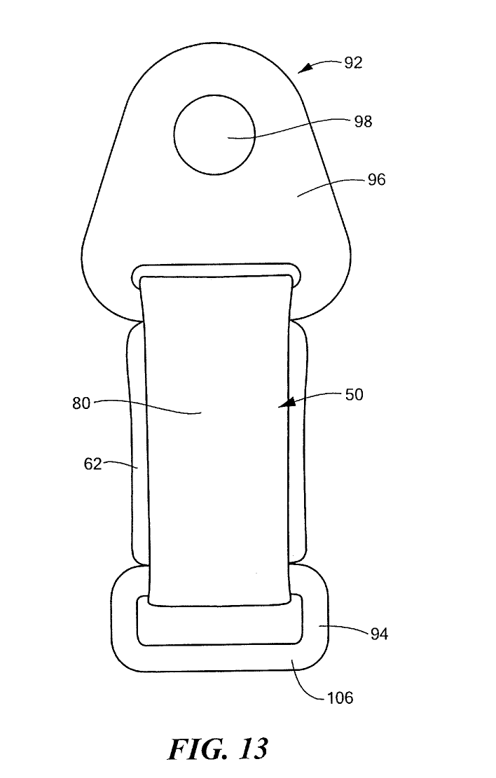

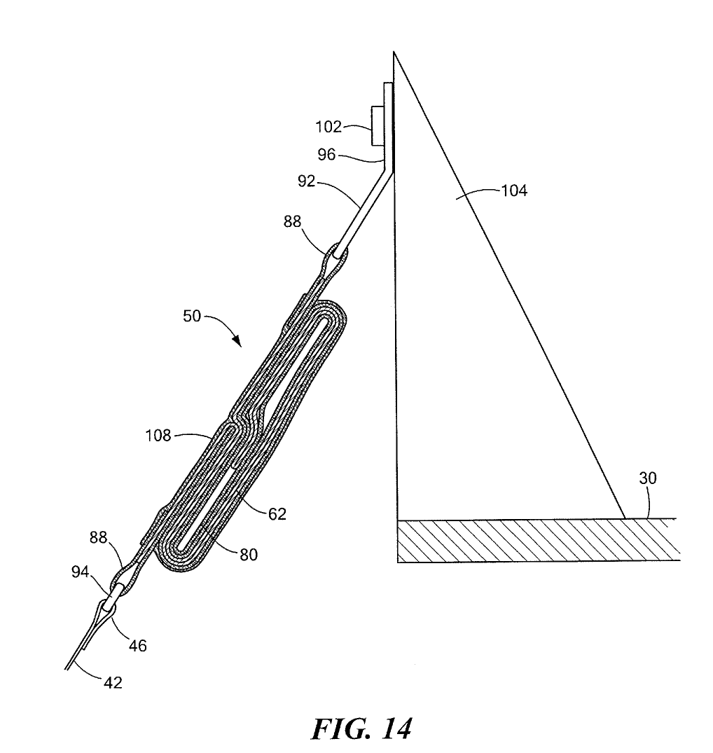

In FIGS. 12-14 the energy absorbing element 50 is attached between the upper end 46 of the suspension element 42 and the vehicle. Suitable fixtures 92, 94 are provided on each end of the energy absorbing element 50 to attach to the vehicle and to the suspension element 42. In the embodiment illustrated in FIGS. 13 and 14, the energy absorbing element 62 is folded into the contracted configuration with a safety strap 80 (illustrated schematically with cross hatching for clarity in FIG. 14), and the safety strap includes loops 88 (see also FIG. 11) on each end that attach to each of the fixtures 92, 94. In one embodiment, the fixture 92 includes a plate 96 with an opening 98 for a bolt or screw 102 that fastens to a bracket 104 on the vehicle 30. The fixture 94 includes a link 106 that receives a loop on the suspension element 42. Alternatively, one or both fixtures 92, 94 can be detachable, such as a carabiner or any other latch mechanism that can be operated by the occupant of the seat.

The energy absorbing element 50 may also be encased in a breakaway casing 108 of, for example, a soft plastic, rubber, or cloth material, to keep the folds of the extensible section in the contracted configuration and protected from inadvertent damage and from getting in the way of the occupant. The casing readily rips open when the retention element of the energy absorbing element begins to fail.

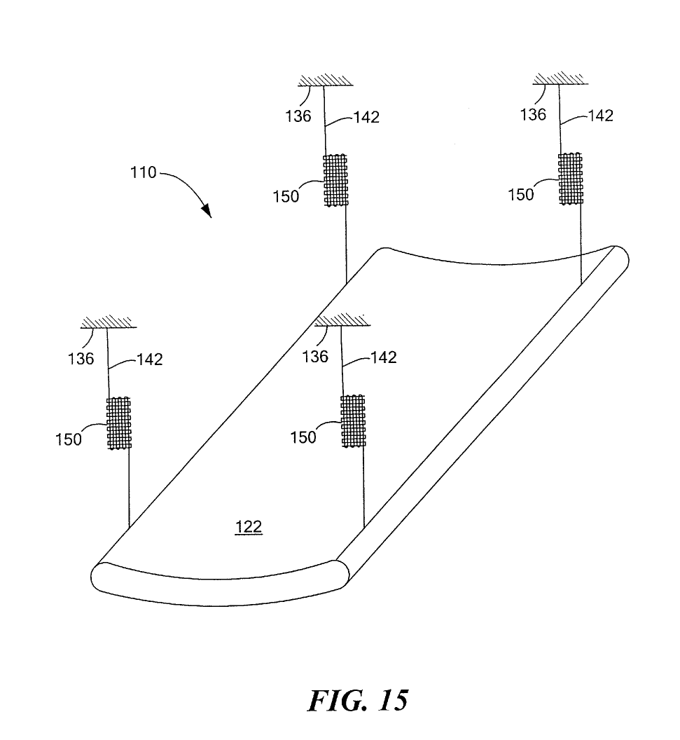

In some military vehicles for medical purposes, one or more stretchers are suspended from the ceiling of the vehicle. As noted above, during an under vehicle blast, the vehicle jumps up suddenly in the vertical direction. Such a sudden movement can place high acceleration (i.e., g) loads on the stretcher and stretcher occupant. These high loads are short in duration, but can injure the occupant of the stretcher when hung in the usual way. FIG. 15 illustrates an embodiment in which an energy absorbing system 110 is used in conjunction with such a suspended medical stretcher 122 to absorb these sudden loads and help isolate the occupant from the blast. The stretcher is suspended from the ceiling 136 of a vehicle by four suspension elements 142, two on each side of the stretcher, although any suitable number can be used. An energy absorbing element 150 is located in series with at least one suspension element. As shown, an energy absorbing element is located within each of the suspension elements. The energy absorbing element can have any configuration, such as described above. The stretcher is preferably rigid so that it does not bend and store energy. The more flexible the stretcher, the more energy the stretcher stores, like a stretched spring, and it could propel the occupant into the roof just after the blast. Multiple energy absorbing elements could also be used along each side of the stretcher to help minimize the tendency for the stretcher to flex and store energy.

Other types of seats in military vehicles are often suspended by ropes in an attempt to mitigate the shock loading from a blast. These designs are also prone to the shortcomings of a spring-only system. The g load on the occupant continues to increase as the seat deflects. There is a tendency for the seat to spring back and throw the occupant after it deflects, and some of the ropes can lose tension and go slack allowing the seat to move in an uncontrolled manner. In addition, the ropes acting as springs are not optimum energy absorbers. Pre-tensioning of the ropes is used to help improve performance and minimize the potential for slack ropes, but the improvement is marginal.

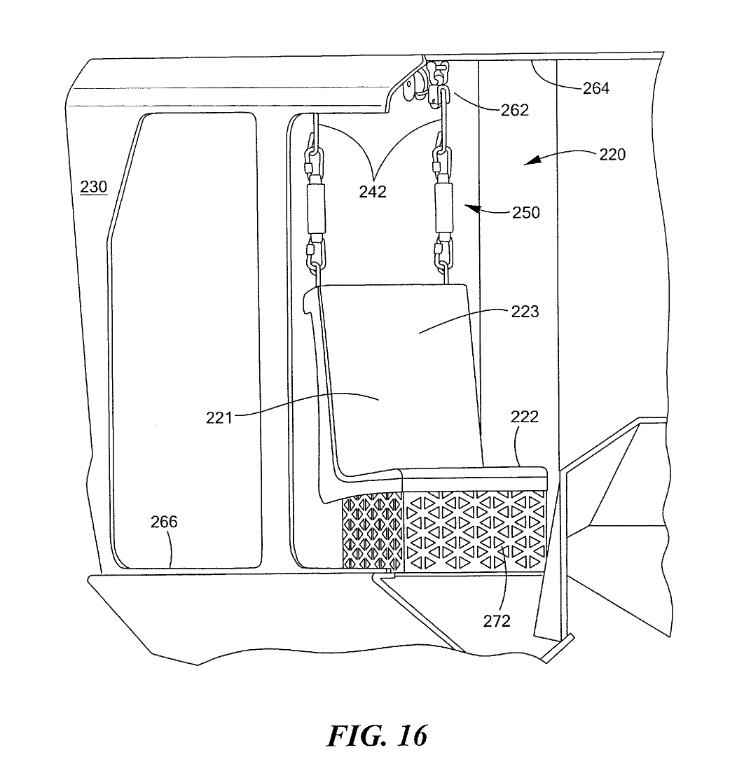

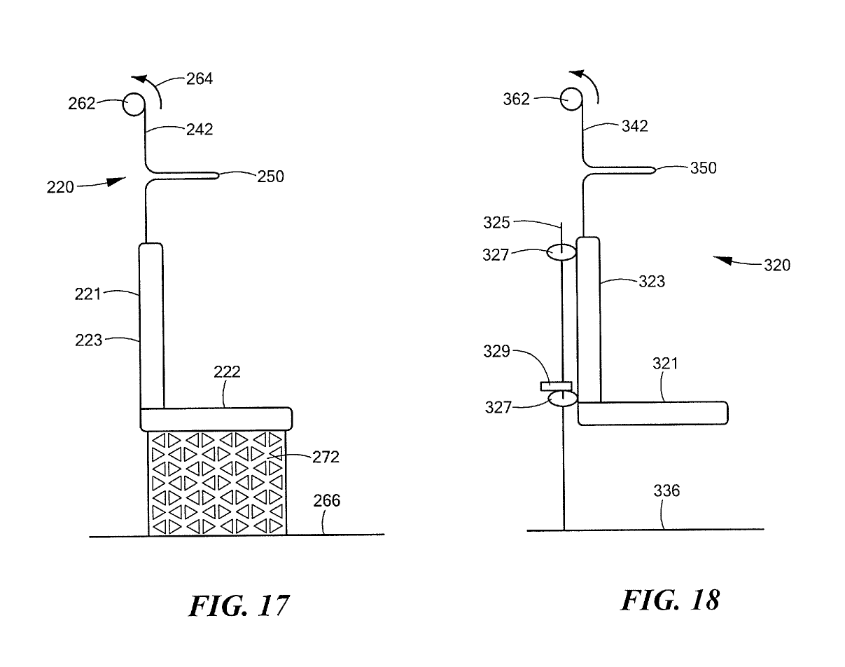

Such rope seat systems can be improved by using an energy absorbing element in the system as described above. For example, FIGS. 16 and 17 illustrate a seat 221, which includes a rigid support surface 222 and a rigid back 223, suspended from a vehicle ceiling with a suspension system 220 that includes two suspension elements 242 attached at their lower ends to the seat back 223. An energy absorbing element 250 is disposed in series with each suspension element as described above. Each suspension element terminates at a retraction mechanism 262 mounted to, for example, the ceiling 264 of the vehicle 230. The retraction mechanism 262 may operate as a seat belt retraction mechanism operates, by including, for example, a unidirectional ratchet tension mechanism. The tension mechanism takes up slack in the suspension element 242 when the tension is low, winding up in the direction of the arrow 264 in FIG. 17. The tension mechanism locks when a high tension load is applied, preventing unwinding in the opposite direction of the arrow. Although two suspension elements are illustrated in this embodiment, a single suspension element with a retraction mechanism and energy absorbing element can be used. Alternatively, more than two suspension elements, each with a retraction mechanism and energy absorbing element, can be used, for example, for wider seats or benches. As noted above, the suspension elements should also be made as stiff as possible to minimize stored elastic energy.

FIGS. 16 and 17 also illustrate a crushable stabilizer element 272 below the support surface of the seat, which can be used in addition to the energy absorbing element. The stabilizer element is fastened to the underside of the support surface 222 and to the floor 266 of the vehicle to center the seat and retain it in position during normal operation. The stabilizer element is in the form of a cage or other structure that is able to crush if necessary when the seat moves downwardly with respect to the vehicle, absorbing further energy.

In another embodiment, illustrated in FIG. 18, a seat 321 is suspended in a military vehicle with a suspension system 320 incorporating an energy absorbing element 350 disposed is series with a suspension element 342 and attached at, for example, the ceiling via a retraction mechanism 362, as described above. The seat is also mounted to one or more vertical guide bars 325. The guide bar may be a rigid rod, such as of metal or a composite material, or a tensioned rope that is fixed to the vehicle frame 336 in any suitable manner. One or more seat slides 327 are fixed to the seat back and are configured to slide vertically along the guide bar. In this manner, the seat is constrained to move only vertically along the guide bar or bars. The slides can have any suitable configuration. For example, the slides can be ring-shaped to fit over the guide bar, or they can fit within or over tracks formed along the guide bar. A seat stop 329 is fixed to the guide bar to prevent further upward movement beyond a preset location of the seat under tension from the suspension element 342. The seat stop can be adjustably fixed to the guide bar if desired. The seat stop does not prevent the seat from moving downwardly. Generally two guide bars are used, and two seat slides are provided for each guide bar.

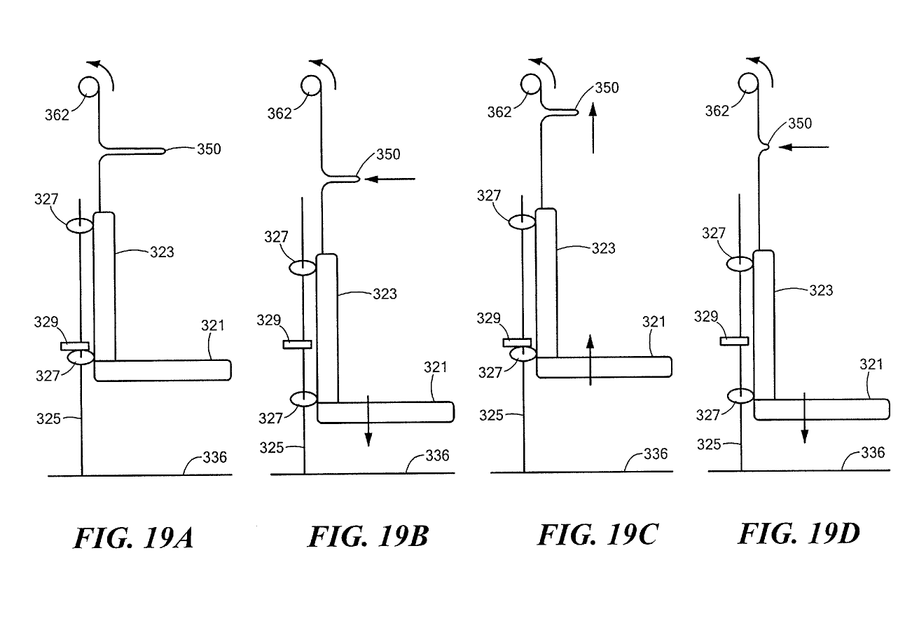

Operation of the energy absorbing system, as illustrated in of FIG. 18, is shown in FIGS. 19A-19D. FIG. 19A illustrates the seat before a blast event has occurred. When a blast occurs beneath the vehicle, the vehicle initially moves upwardly, and the seat moves downwardly relative to the vehicle. The retraction mechanism locks. The energy absorbing system begins to extend. See FIG. 19B. The seat becomes weightless. During weightlessness, the seat moves up under the action of the retraction mechanism, until the seat stop is reached. See FIG. 19C. During landing, the retraction mechanism locks and the seat moves downwardly as the absorbing system continues to extend. See FIG. 19D

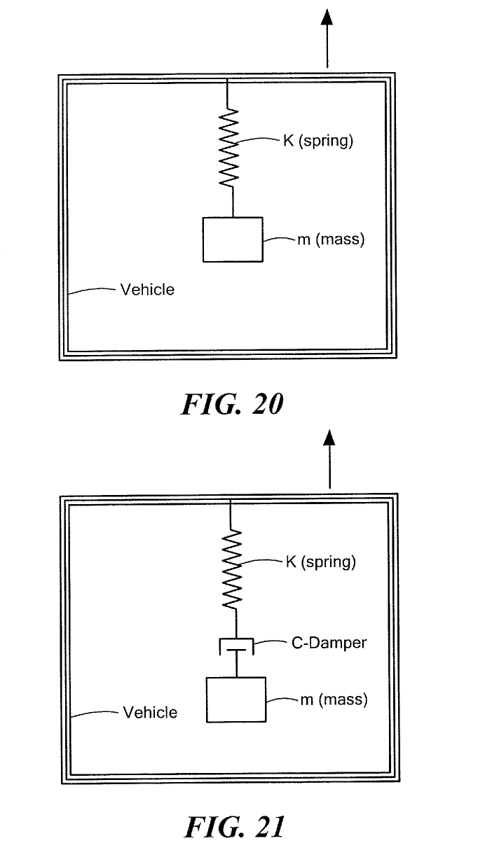

A simple model illustrates the advantage of the energy absorbing system for a gunner seat application. Two phases are modeled, the take-off phase, and the ejection phase without restraint. The unrestrained ejection height is used to gauge the tendency for ejection. In a base model (referring to FIG. 20), the gunner is modeled as a mass m. The gunner is suspended from the vehicle roof by a spring representing the seat webbing suspension, modeled as a spring of spring constant k. The spring only works when the gunner moves down relative to the vehicle cab. If the gunner moves above the cab the spring is not active; this is to show the tendency to launch the gunner after the event.

Just after the blast, the vehicle is assumed to be in motion with upward velocity V₀, but it has not yet displaced appreciably. Just after the blast the gunner is at rest.

Since the mass of the vehicle is much greater than the mass of the gunner, in the model the motion of the vehicle is assumed to be unaffected by the gunner. The vehicle moves upwardly with initial velocity V₀, and slows under the force of gravity, eventually returning to the ground where it is assumed to be at rest from that point on. The motion of the vehicle forms the forcing function for the system.

Referring to FIG. 21, the model is the same as the base model except that an energy absorbing element has been added in series with the seat suspension straps. There may be more than one energy absorbing element used in a typical application, one on each side of the seat for example, but they are represented in the model as a single energy absorbing element all acting together. The energy absorbing element has an initiation load Fᵢ and a constant load during extension F_{c}.

Once the initial upward velocity of the vehicle V₀ is given, the motion of the vehicle is prescribed. The vehicle's upward velocity is slowed under the force of gravity, and the vehicle returns to the ground.

The motion of the suspended mass (the gunner) is solved for using a time stepping integration routine given the system parameters, and the motion of the vehicle.

As an example, the following conditions were investigated for the base model without the energy absorbing element:
Occupant mass m (gunner): 114 kg (about 250 pounds weight, or 7.7 slugs mass)
Seat spring constant: 10000 pounds/foot (about 830 pounds/inch, or 146000 Newtons/meter)
Initial vehicle velocity V₀: 16 feet/second (about 4.9 meters/second), this results in a vehicle jump height of about 4 feet.

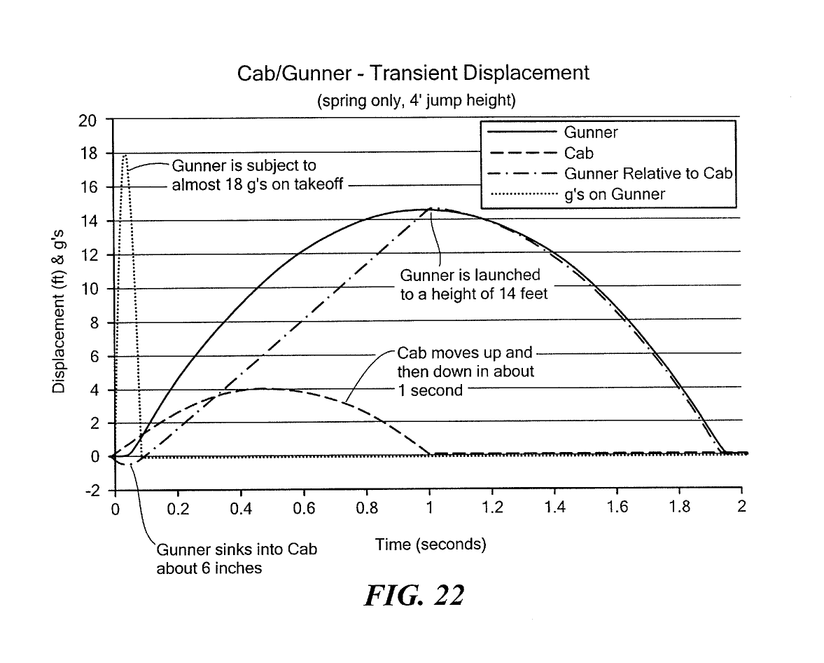

The transient results are shown in FIG. 22 for the base model without the energy absorbing element. Note that the maximum load on the occupant is about 18 g, and will tend to eject the occupant to a height of over 14 feet. Again, this model does not have a mechanism to hold the occupant in the vehicle. The unrestrained ejection height is used as an indication of the tendency to eject the occupant. Judging from the expected ejection height of 14 feet, it would take considerable restraint to hold the occupant in the vehicle.

The same parameters were then investigated with an energy absorbing element added in series with the spring.
Occupant mass m (gunner): Same as base model.
Seat spring constant: Same as base model.
Initial vehicle velocity V₀: Same as base model.
Energy absorbing element: Initiation force Fᵢ of 1000 pounds, and a constant extension force F_{c} of 1000 pounds (initiating and extending at about 4 g for the 250 pound occupant)

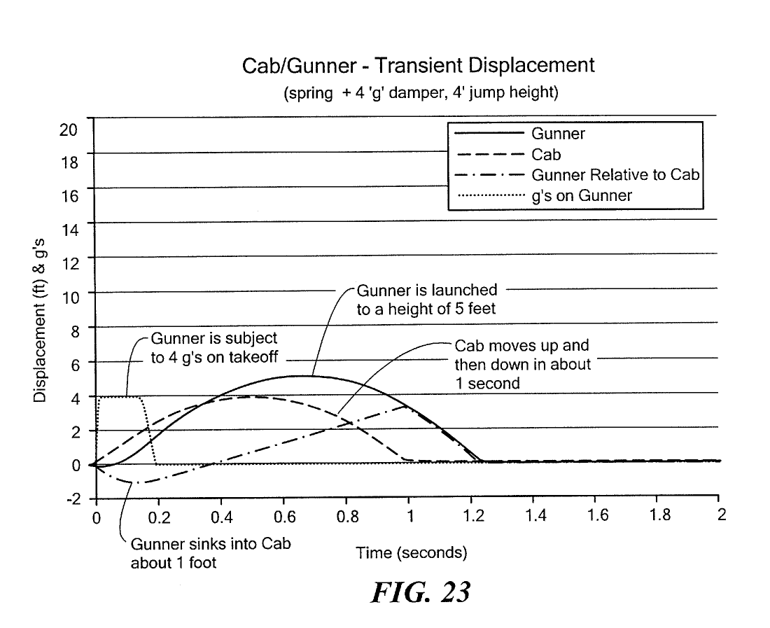

The transient results are shown in FIG. 23 for the model with the energy absorbing element. The effectiveness of the energy absorbing element can be seen, by reducing the maximum load on the occupant from 18 g without the energy absorbing element down to 4 g with the energy absorbing element. The tendency for ejecting the occupant is reduced, as observed in the lower unrestrained ejection height of about 5 feet with the energy absorbing element, as compared to 14 feet without the energy absorbing element.

The energy absorbing system has been tested with a crew seat and a gunner sling seat.

### Crew Seat Test

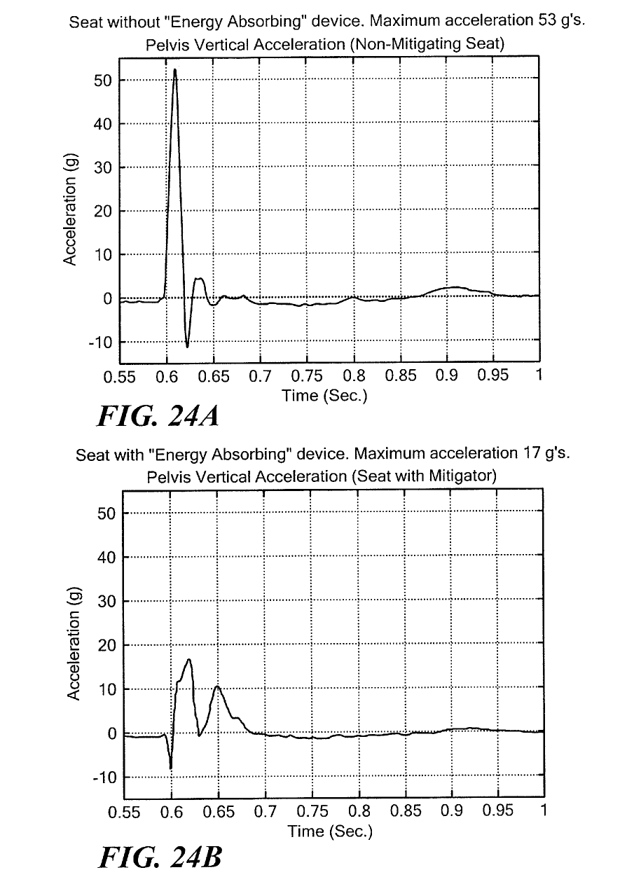

FIG. 24A illustrates the acceleration of a crew seat (in g's) without an energy absorbing element, and FIG. 24B illustrates the acceleration of a crew seat (in g's) with an energy absorbing element. The maximum acceleration without the energy absorbing element was 53 g's. The maximum acceleration of a crew seat with the energy absorbing element was 17 g's.

### Sling Seat Test

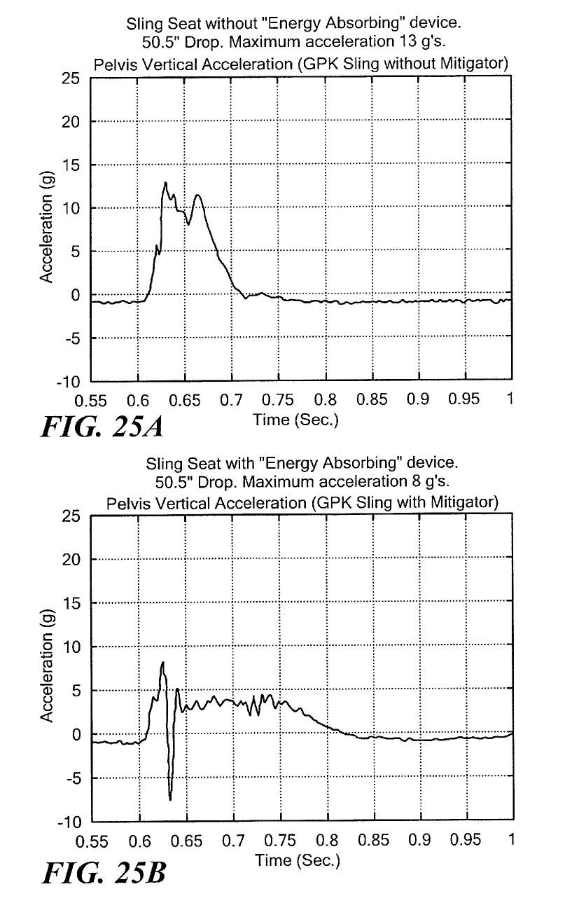

FIG. 25A illustrates the acceleration of a sling seat (gunner seat) (in g's) without an energy absorbing element, and FIG. 25B illustrates the acceleration of a sling seat (in g's) with an energy absorbing element. The maximum acceleration without the energy absorbing element was 13 g's. The maximum acceleration of a sling seat with the energy absorbing element was 8 g's.

The energy absorbing system can provide surprisingly dramatic reductions. The energy absorbing system is effective in reducing adverse effects on occupants for all three phases of vehicle motion following an underbelly blast. During the take-off phase, the initial g loading on the occupant is greatly reduced. During the ejection phase, the tendency to eject the occupant is greatly reduced, making the use of a restraining harness safer and more effective. During the landing phase, if the energy absorbing element is not fully extended during the take-off phase, residual damping capability is available to soften the landing as well.

It will be appreciated that features of the various embodiments and examples described herein can be combined in different ways from those explicitly shown and described. The invention is not to be limited by what has been particularly shown and described, except as indicated by the appended claims.

What is claimed is:

1. An energy absorbing system for a suspended support element for a person in a vehicle, comprising:
a support element comprising an upwardly facing support surface, the support surface configured to support a person in a sitting or lying position;
a suspension system attachable to the support element and to an upper structural member of the vehicle to suspend the support element from the vehicle, the suspension system comprising at least one suspension element and at least one energy absorbing element disposed in series with the suspension element;
wherein the energy absorbing element is capable of carrying a tensile load and comprises:
an extensible section having a contracted configuration and an extended configuration, the contracted configuration comprising one or more folds of the extensible section retained in a folded orientation with adjacent portions abutting, and
a retention element disposed to retain the extensible section in the contracted configuration,
the retention element configured to remain intact when the suspension element supports a load from a person on the support element and to fail over a period of time when an explosive force is applied to the vehicle from underneath causing the vehicle to move upwardly, the extensible section thereby extending in length and absorbing energy.

2. The system of claim 1, wherein the retention element comprises stitching through the adjacent portions of the extensible section in the contracted configuration.

3. The system of claim 1, wherein the retention element comprises entangled interlocking fibers extending through adjacent portions of the extensible section in the contracted configuration.

4. The system of claim 1, wherein the energy absorbing element is comprised of a fibrous material.

5. The system of claim 4, wherein the energy absorbing element is comprised of nylon fibers, polymeric fibers, or natural fibers.

6. The system of claim 1, wherein the energy absorbing element comprises a strap comprised of a woven webbing.

7. The system of claim 1, wherein the suspension element is comprised of a fibrous material.

8. The system of claim 1, further comprising a safety strap disposed in parallel with the energy absorbing element, the safety strap having a length longer than a length of the energy absorbing element in the extended configuration, the safety strap foldable into the contracted configuration with the extensible section.

9. The system of claim 8, wherein the safety strap is attached to the energy absorbing element at opposite ends of the energy absorbing element.

10. The system of claim 1, wherein the energy absorbing element includes a first attachment fixture at one end to attach to the vehicle and a second attachment fixture at an opposite end to attach to the suspension element.

11. The system of claim 10, wherein one or both of the first attachment fixture and the second attachment fixture are detachable.

12. The system of claim 1, wherein the suspension element comprises a strap, and the energy absorbing element is integrally formed within the strap of the suspension element.

13. The system of claim 1, further comprising a breakaway casing disposed over the energy absorbing element in the contracted configuration.

14. The system of claim 1, wherein the suspension system further includes a retraction mechanism attachable to the upper structural member of the vehicle and operative to take up slack in the suspension system when a tensile load is below a determined load and lock when a tensile load is above the determined load.

15. The system of claim 1, further comprising at least a second suspension element and at least a second energy absorbing element disposed in series with the second suspension element.

16. The system of claim 1, wherein the support element comprises a gunner seat or a sling seat in a military vehicle.

17. The system of claim 1, wherein the support element comprises a medical stretcher.

18. The system of claim 1, wherein the support element comprises a seat, and the suspension system further includes a vertical guide bar configured to constrain the seat to vertical motion.

19. The system of claim 18, further including a stop on the guide bar to limit upward vertical motion of the seat.

20. A vehicle comprising:
a vehicle body having a roof; and
the energy absorbing system of claim 1 attached to the roof of the vehicle body.

21. The vehicle of claim 20, wherein the suspension system is attached beneath an opening in the roof of the vehicle.

22. An energy absorbing element for use in series with a suspended seat or stretcher for a person in a vehicle, comprising:
a longitudinal element comprising a strap member extending longitudinally from one end to an opposite end, the strap member including an extensible section having a contracted configuration and an extended configuration, the contracted configuration comprising one or more folds of the strap member retained in a folded orientation with adjacent portions abutting, and
a retention element disposed to retain the extensible section in the contracted configuration,
the retention element configured to remain intact when the suspension element supports a load from a person on the support element and to fail over a period of time when an explosive force is applied to the vehicle from underneath causing the vehicle to move upwardly, the extensible section thereby extending in length and absorbing energy;
a connection fixture located at the one end and configured to connect to a structural member of a vehicle, and
a further connection fixture located at the opposite end and configured to connect to a suspension element of the seat or stretcher.

23. The energy absorbing element of claim 22, wherein the retention element comprises stitching through the adjacent portions of the extensible section in the contracted configuration.

24. The energy absorbing element of claim 22, wherein the retention element comprises entangled interlocking fibers extending through adjacent portions of the extensible section in the contracted configuration.

25. The energy absorbing element of claim 22, further comprising a safety strap disposed in parallel with the strap member, the safety strap having a length longer than a length of the strap member in the extended configuration, the safety strap foldable into the contracted configuration with the extensible section.

26. The energy absorbing element of claim 25, wherein the safety strap is attached to the strap member at the one end and the opposite end of the strap member.

27. The system of claim 22, wherein the strap member is comprised of a woven webbing.

28. The energy absorbing element of claim 22, wherein one or both of the connection fixture and the further connection fixture are detachable.

29. The energy absorbing element of claim 22, further comprising a breakaway casing disposed over the longitudinal element in the contracted configuration.

30. A method of absorbing energy from a blast beneath a vehicle, the vehicle including at least one seat or stretcher suspended in the vehicle, comprising:
disposing an energy absorbing element in series with a suspension element of the seat or stretcher, the energy absorbing element comprising an extensible section having a contracted configuration and an extended configuration, the contracted configuration comprising one or more folds of the extensible section retained in a folded orientation with adjacent portion abutting, and a retention element disposed to retain the extensible section in the contracted configuration;
in the event of a blast underneath a vehicle, absorbing energy by failure of the retention element over a period of time to extend the energy absorbing element from the contracted configuration.
